(19) United States
(12) Patent Application Publication
(10) Pub. No.: US 2026/0357726 A1
(43) Pub. Date: Nov. 12, 2026

(54) METHOD FOR DETECTING AN OIL DEPOSIT IN AN INTERNAL COMBUSTION ENGINE

(71) Applicant: Schaeffler Technologies AG & Co. KG, Herzogenaurach (DE)

(72) Inventors: Bruno Vialan, Toulouse (FR); Stéphane Eloy, Tournefeuille (FR)

(21) Appl. No.: 19/515,674

(22) PCT Filed: Aug. 28, 2024
(86) PCT No.: PCT/EP2024/073999

§ 371 Date: Mar. 2, 2026

(30) Foreign Application Priority Data
Sep. 1, 2023 (FR) FR2309193

(51) Int. Cl. F01M 11/10

(52) U.S. Cl. CPC F01M 11/10; F01M 2011/142

(57) ABSTRACT

Method with:
a first initialization step 100. During a foot-off phase, an operation of learning the passage times of each tooth is carried out over four engine revolutions. The time required for the first two rotations of the engine and for the next two rotations are measured and during these, all of the tooth passage times are measured;
a second step 200 of determining a rate of change in rotational speed;
a third step 300 using the rate of change in speed to correct each of the measured tooth passage times;
an optional fourth step 400 of calculating an average of the corrected tooth passage times;
a fifth step 500 of analyzing the measurements carried out and of processing the corrected calculated values;
a final step 600 corresponds to evaluating the calculations made to deduce therefrom an estimate regarding the presence of oil deposits.

### CROSS-REFERENCE TO RELATED APPLICATION

The present application is the U.S. National Phase of PCT Patent Application Number PCT/EP2024/073999, filed on Aug. 28, 2024, which claims priority to French Patent Application Number FR2309193, filed Sep. 1, 2023, the entire disclosures of which are incorporated by reference herein.

### TECHNICAL FIELD

The present disclosure relates to a method for detecting an oil deposit in an internal combustion engine.

The present disclosure relates to the field of the automotive industry and relates more particularly to internal combustion engines.

### BACKGROUND

Conventionally, in an internal combustion engine, pistons slide in cylinders and, through a connecting-rod/crankshaft system, rotate a flywheel, and this movement is passed on to the wheels of the vehicle in order to move same. The combustions take place in combustion chambers. Each piston forms a partition between the corresponding combustion chamber and a crankcase in which the connecting-rod/crankshaft system moves. Oil is present in the crankcase to lubricate the moving parts.

In order to know the position of the pistons in the engine, it is usual to use both a sensor associated with a target linked to the crankshaft driven in rotation by the pistons via connecting rods, and a sensor associated with a target linked to a camshaft, the latter controlling the intake and expulsion of the gases in the combustion chambers. In a four-stroke engine, a combustion cycle takes place over two revolutions (720°) of the crankshaft and a camshaft rotates at a rotational speed corresponding to half the rotational speed of the crankshaft. The target linked to the crankshaft makes it possible to use the corresponding sensor to precisely know the position of the crankshaft over one revolution (or 360° also referred to as 360°CRK) while the target linked to a camshaft makes it possible to use the corresponding sensor to determine whether the combustion cycle is at the beginning of the cycle (between 0 and 360°CRK) or at the end of the cycle (between 36° and 720°CRK). To summarize, the crankshaft sensor makes it possible to know the position of the engine modulo 360°CRK and the camshaft sensor makes it possible to know the position of the engine modulo 720°CRK.

The rotational speed of the engine corresponds to the rotational speed of the crankshaft. The target linked to this crankshaft is generally a toothed circular target, with similar teeth distributed evenly on the periphery of the target. There is usually one tooth every 6° on the periphery of the target (i.e. theoretically 60 teeth), but there are two teeth missing in order to create a singularity on the periphery of the target and thus mark each crankshaft revolution. All of this is known to a person skilled in the art, who knows that such a target is associated with a sensor (usually an inductive sensor) that detects each passage of a tooth in front of it and supplies a signal that makes it possible to know both the instantaneous position and the rotational speed of the engine. The sensor also makes it possible to know the time (duration) elapsed between the passage of one tooth and the next tooth.

The (toothed) target is in contact with the oil in the crankcase and sometimes the oil is deposited on (the teeth of) the target. Several causes can be responsible for such a deposition. When the engine is frequently idling, and the vehicle is frequently making short trips, there is a risk of oil circulating improperly and being deposited. The oil can also be contaminated with metallic or non-metallic impurities and/or with moisture (or condensation water). Various causes can degrade the quality of the oil, leading to a change in its viscosity and causing it to be deposited, for example on the crankshaft target.

For good engine health, it is necessary to have good-quality oil in good condition. On the one hand, it is necessary to have quality oil in order to guarantee excellent lubrication and on the other hand it has been found that, in some cases, even if the lubrication is sufficient, oil analysis can reveal a problem relating to the operation of the engine.

Currently, in order to know the quality of the oil, it is necessary to analyze it and this requires it to be accessible. It is usually accessed via a hole for an oil dipstick or via a drain plug.

### SUMMARY

The present disclosure provides a method for detecting an oil deposit on the toothed target of the crankshaft. This information makes it possible to inform the driver of the vehicle that the engine oil needs to be changed. The method is an automated method that does not require driver intervention.

The present disclosure provides, among other things, a method for detecting an oil deposit in an internal combustion engine is proposed, said engine comprising a crankshaft provided with a toothed target, characterized in that it comprises the following steps:
a—an initialization step comprising the following sub-steps:
a1—detecting an operating phase during which no combustion is carried out in the engine,
a2—determining an initial rate of change in engine speed and measuring an initial passage time for each tooth of the toothed target over 360°CRK (angle corresponding to the rotation of one crankshaft revolution) or 720°CRK,
a3—determining a corrected initial passage time for each tooth of the toothed target by taking into account the rate of change in engine speed, and
a4—storing the corrected initial tooth passage times in a non-volatile memory,
b—a measuring step comprising the following sub-steps:
b1—detecting an operating phase during which no combustion is carried out in the engine,
b2—determining a current rate of change in engine speed and measuring a current passage time for each tooth of the toothed target over the same interval (360°CRK or 720°CRK) (in other words, an interval of the same size as the interval of 360°CRK or 720°CRK in step—a2-),
b3—determining a corrected current passage time for each tooth of the toothed target by taking into account the current rate of change in engine speed,
b4—storing the corrected current tooth passage times,
c—an analysis step comprising the following sub-steps:
c1—for each tooth, comparing the corrected current passage time with an average passage time, and calculating a relative rate of change between these two times,
c2—calculating a factor representative of the relative rates of change of step-c1—for all of the teeth (in other words, a factor representative of the relative rates of change of step-c1—associated with each of the teeth of the toothed target),
c3—calculating the factor of step-c2—using the corrected initial passage times stored in step-a4—(in other words, a factor corresponding to the factor of step-c2-, by replacing each corrected current passage time with the corresponding corrected initial passage time as stored in step-a4-), and
c4—detecting an oil deposit if the factor calculated in step-c3—differs from the factor calculated in step-c2—by more than a predetermined value.

This method thus makes it possible, by using only means present in almost all motor-vehicle combustion engines, to control the quality of the engine oil and/or to detect an abnormal oil deposit in the engine.

The features set out in the following paragraphs can optionally be implemented independently of one another or in combination with one another:
in step-a2—and step-b2—, a first time T_1 required for the engine to perform a first rotation of 720°CRK is measured, then, during a second rotation of 720°CRK immediately following the first rotation of 720°CRK, both a second time T_2 required for the engine to perform the second rotation of 720°CRK and the passage times for each tooth are measured, and the rate of change in speed DECEL is calculated according to the formula:

DECEL=(T_2−T_1)/T_1;

in addition, the correction rate CDF for calculating the corrected passage time in steps-a3—and—b3—may in this case be:

CDF=DECEL*n/N

for the teeth in the interval [(n−1)*720°CRK; n*720°CRK],
with N being an integer and n<=N;
in step-c1-, the relative rate of change TVR in the corrected current passage time T_mes_corr and in the average passage time T_moy is given by the formula:

TVR=1−(T_mes_corr/T_moy),

where T_moy corresponds to the sum of the current passage times (step-b2-) divided by the number of current times measured over the measurement interval;
the factor of step-c2—consists of a sum of positive numbers, for example, a sum of absolute values of relative rates of change or a sum of squares of relative rates of change;
the method also includes a warning step when an oil deposit has been detected in step-c4-.

The present disclosure provides, among other things, a computer program comprising instructions for implementing all or part of a method as defined herein when this program is executed by a processor. According to another aspect, a non-transitory computer-readable storage medium is proposed that stores such a program.

The present disclosure provides, among other things, an electronic control unit for managing an internal combustion engine is proposed, characterized in that it comprises means for implementing each of the steps of a method as defined herein.

The present disclosure provides, among other things, a motor vehicle comprising an internal combustion engine with a crankshaft and a toothed target secured to said crankshaft is proposed, characterized in that it comprises an electronic control unit as defined above.

### BRIEF DESCRIPTION OF THE DRAWINGS

Further features, details and advantages will become apparent upon reading the following detailed description and from examining the appended drawings, in which:

FIG. 1 schematically shows two teeth of a crankshaft target in a new engine.

FIG. 2 schematically shows the two teeth of FIG. 1 with an oil deposit.

FIG. 3 shows a flowchart corresponding to a method according to the present disclosure.

FIG. 4 schematically shows a vehicle for implementing the present disclosure.

### DETAILED DESCRIPTION

The following description is made with reference to a thermal combustion engine M (FIG. 4) comprising N cylinders in each of which a piston slides. Each piston is connected by a connecting rod to a crankshaft driven in rotation by the sliding movement of the pistons in their cylinders. The rotational movement is transmitted via a transmission to the wheels of a vehicle V (FIG. 4). In order to know the position of the pistons in the cylinders and also the engine speed, it is known practice to secure a target to the crankshaft. Conventionally, for a motor-vehicle engine, the target has teeth at its periphery, one tooth being provided every 6°, giving a total of 60 teeth. In order to create a singularity and recognize the beginning of a new crankshaft revolution, it is usual to remove two teeth and leave a corresponding free space. A sensor, generally an inductive sensor, is fixedly mounted facing the target and detects the passage of each of the teeth of the target. It provides a signal that makes it possible to precisely determine the time interval between the passage of two teeth. As is known to a person skilled in the art, such a sensor may detect either the rising edges of a tooth or the falling edges.

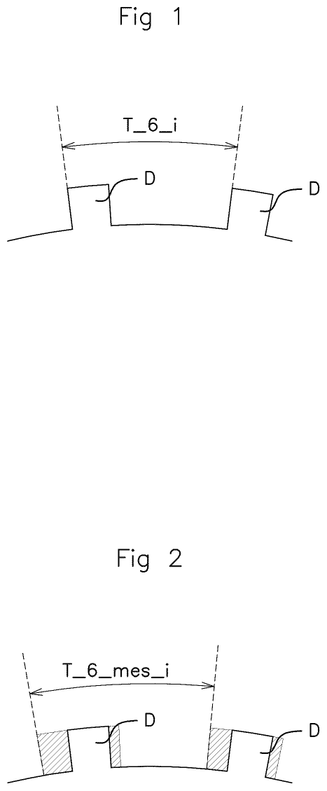

FIG. 1 schematically shows two teeth D of a target in a new engine while FIG. 2 shows the same teeth D after use and covered with oil. The oil often contains metal particles and these can be detected by the inductive sensor associated with the toothed target, thus risking an erroneous measurement. The idea on which the present disclosure is based is to observe whether the tooth edges detected by the sensor are always distributed in the same way around the periphery of the target or whether the position of the edges detected varies over time. It is then proposed to look at the position of the edges when the engine is new, to store these positions for the service life of the engine and, by means of regular measurements, to compare the position of the edges with their original position. A corresponding method is described below.

As is apparent from the presentation of the method proposed here, it is necessary to look at and store the position of the tooth edges detected by the sensor associated with the crankshaft target as soon as possible when the engine is started up.

It is proposed to carry out identification over the entire periphery of the target under predetermined conditions, with as little disturbance as possible, i.e. when there is no combustion in the engine. This occurs in particular when the driver removes their foot from the accelerator and the demand for torque to be supplied by the engine is zero. Such a phase of operation of the engine is referred to as “foot-off” phase or is also known as “pedal up cut off” or PUC. The measurements that will be made in the following method will be made under these conditions. A first step is therefore first of all the detection of a foot-off phase during driving of the vehicle.

During a foot-off driving phase, with a gear engaged, the speed of the vehicle will generally decrease unless it is on a (steep) downhill slope. Its speed varies along with the engine speed. In order to know the distribution of the tooth edges at the periphery of the target, this deceleration should then be taken into account.

For better repeatability, according to a preferred (but optional) operating mode, each measurement should be started on the same edge. The measurements that are subsequently made are all made starting from the same position of the pistons in the engine. This corresponds to a given angular position of the engine over 720°CRK, i.e. a predetermined position for each complete combustion cycle of the engine. This position corresponds to a passage of a tooth edge in front of the sensor. This tooth edge is not a singular edge such as, for example, the last edge before the free space of the tooth or the first edge after this space.

For the same sake of precision and repeatability, it is also proposed to make each measurement over two crankshaft revolutions (720°CRK), i.e. over a complete combustion cycle. Thus, the measurement takes into account all the particular phenomena that are likely to occur. However, a measurement carried out over 360°CRK may be considered and is also fruitful. If the engine is not a four-cylinder engine, the same starting point should always be chosen for making the measurements over 360°CRK. A measurement over 720°CRK is recommended (even with a four-cylinder engine) and throughout the remainder of the description, only this alternative will be mentioned (even if it is possible to make measurements only over 360°CRK).

This having been specified, an initialization step can be described. First of all, a foot-off phase is detected. The passage of a reference edge in the “correct” rotational revolution of the crankshaft (as is mentioned in the preamble and is perfectly known to a person skilled in the art, the position of a camshaft makes it possible to know the position of the engine modulo 720°CRK) is then waited for. A time measurement begins. This involves determining how long it takes the engine to make two revolutions (or 720°CRK): let T_720_1 denote this reference time.

The measurement continues, but during the third and fourth revolutions, not only is the overall time for performing these two revolutions, for example denoted T_720_2, measured, but also the passage times for each tooth referred to as T_6_i for the i^{th} tooth are recorded, i in this case varying from 1 to 120. For the tooth-free part of the target, the passage time measured is divided by three (for two missing teeth) and a time is stored as if the missing teeth were present.

Since the average engine speed changes (usually) during this input, in order to be able to compare the passage times with one another, the change in speed must be taken into account. It is proposed to calculate a first rate of change in speed: DECEL=(T_720_2−T_720_1)/T_720_1.

A rate of change in speed is thus obtained that can be considered to be substantially constant and changing relatively little. At the beginning of the time measurement T_6_i, for a small value of i, there is no (or a very small) correction to be made, but for a larger value of i, close to 120 in the example, a correction rate corresponding substantially to DECEL will have to be applied.

It is possible to adapt a correction rate for each time T_6_i. For example, the rate DECEL*(i/120) would be used for T_6_i.

Another proposition is made here. Since the changes in engine speed are related to the compression/expansion phases in the cylinders, a correction rate is applied for each cylinder. As indicated above, N is the number of cylinders of the engine in question. A rate CDFn per cylinder is determined for n varying from 1 to N. This gives:

CDFn=DECEL*n/N

On the basis of this correction rate, a corrected time will be calculated for each measurement T_6_i using the formula:

T_6_cor_i=T_6_i*CDFn

for i varying from [(n−1)*120/N+1] to 120*n/N.

All of these values are then stored in a non-volatile memory. This is the reference that can then be used to compare the passage times and to analyze whether there are significant changes and if necessary warn the driver of the vehicle. These stored passage times are initial passage times (or initial times).

This first measurement is made as soon as possible after the engine has been started up in the vehicle. It may be carried out within the first few kilometers of travel, or within the first tens of kilometers of travel.

The measurement may be carried out several times when the engine is new. It is possible to check that the measurements are consistent and to record/store for example the average values of several measurements carried out on an engine considered to still be new.

Thereafter, once the one or more initial values have been stored, new measurements are carried out in the same way. These measurements may be made every foot-off phase, with a gear engaged, every 100 km when a foot-off phase occurs, etc.

The measurement is carried out in the same way as is described above. First of all, a foot-off phase is detected and a rate of change in speed is calculated by taking a first measurement T_720_1 over two revolutions, then a second measurement T_720_2 over the next two revolutions to finally calculate the rate DECEL.

During the second measurement, the current passage times T_6_mes_i corresponding to each tooth of the target are determined. Each time is corrected in the same way as the correction was made for the initial reference times. The corrected current times are determined as follows:

T_6_mes_cor_i=T_6_mes_i*CDFn.

The corrected current times thus determined (T_6_mes_cor_i) are also stored in order to be analyzed.

The measurements can thus be carried out over 720°CRK. If the engine is still in the foot-off phase, one (or more) new measurement(s) can be made and an average of the corrected current times is taken.

If oil is deposited onto the teeth of the target, this is irregular when the quality of the oil has deteriorated. When the oil is new, there may be a regular film of oil. Thus, it is proposed to compare the current passage time of a tooth with the current passage time of the previous tooth. It is therefore proposed to calculate a difference in the current passage time of a tooth compared with an average current passage time:

Delta_i=T_6_mes_cor_i−(T_720_2/120)

where T_720_2 corresponds to the time required to perform the 720°CRK during which the measurements T_6_mes_i were made and
120 corresponds to the number of teeth taken into account during the measurement, including missing teeth (i.e. 2*60 teeth).

Delta_i still has a dimension (this represents a time). In order to obtain a representative factor, which is dimensionless and therefore comparable, it is proposed to divide it by the average current passage time of a tooth (T_moy=T_720_2/120), i.e.:

Fac_i=Delta_i/T_moy

or else

Fac_i=(T_6_mes_cor_i/T_moy)−1.

This factor can be negative or positive; it is important here to know the absolute value or to square it. It is thus proposed to calculate an overall deposition factor FDG_mes using the formula:

FDG_mes=SOMME[(Fac_i)EXP2] for i varying from 1 to 120

or written otherwise:

$$F D G = {\sum }_{i = 0}^{120} {Fac\_i}^{2}$$

The overall deposition factor is calculated in the same way by using the values T_6_i of the initial passage times that have been stored in the non-volatile memory, i.e. FDG_ini, which should normally be close to 0.

If the value of FDG_mes deviates too far from FDG_ini, then it is estimated that the oil should be drained. A threshold Th_Vid can be defined here such that if:

|FDG_mes−FDG_ini|>Th_Vid

a warning is sent to the driver.

Of course, this warning may be sent only if the measurement of the overall deposition factor is above the threshold during two (or more) measurements in order to avoid false alarms.

In the method according to the present disclosure, the values of the overall deposition factor can be stored and the change in this factor recorded. Thus, the factors FDG_mes can also be recorded in a non-volatile memory. Normally, this factor should increase as the condition of the engine oil decreases. The change in this factor can provide an index referred to as “oil deposition speed”. This speed may be an index. Specifically, if this speed is high, it can be assumed that the degradation of the quality of the oil is abnormal and an action other than simply draining should a priori be undertaken.

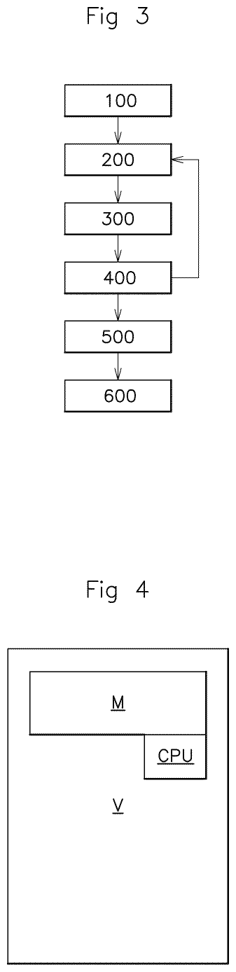

FIG. 3 is a flowchart summarizing the method described above. An electronic unit (CPU in FIG. 4) is programmed to implement this flowchart.

A first step 100 corresponds to the initialization step. During a foot-off operation phase of the engine, as soon as possible, an operation of learning the initial passage times for each tooth is carried out. In an embodiment, this learning operation is carried out over at least four engine revolutions. The time required for the first two rotations of the engine and for the next two rotations are measured and during these last two, all of the initial tooth passage times are measured.

A second step 200 corresponds to determining a rate of change in the engine speed, corresponding to the change in speed of the two following rotations with respect to the first two rotations.

A third step 300 then corresponds to using the rate of change in speed to correct each of the measured tooth passage times.

An optional fourth step 400 corresponds to calculating an average of the corrected tooth passage times. If the foot-off phase is sufficiently long, it is then possible to carry out several successive measurements and to take an average of the corrected values found for each tooth. This applies to both the initialization step and the measurement steps.

An arrow returns from step 400 to step 200 to indicate that the measurements can be continued for as long as the foot-off operating phase continues.

A fifth step 500 corresponds to analyzing the measurements carried out and of processing the corrected calculated values. It is necessary to illustrate here, preferably with a dimensionless factor, the changes in the passage times with respect to an average passage time. This is the calculation of the overall deposition factor proposed above, but another number, which may be dimensionless, may be used here.

Finally, a final step 600 corresponds to evaluating the calculations made to deduce therefrom an estimate regarding the presence of oil deposits in the engine and/or the condition of the oil in the engine. This step may also include sending a warning message, for example illuminating a warning light or editing a message, to the cockpit of the vehicle. It may also include determining a speed of oil deposition in the engine.

The present disclosure, among other things, makes it possible to monitor the quality of the oil of an internal combustion engine in an original and entirely novel way.

Many situations can cause oil deposits in the engine and these deposits often result in deterioration in the quality of the engine oil used for engine lubrication.

There are no means/methods in the prior art for detecting poor oil quality apart from an analysis (for example visual and/or tactile analysis) of the oil by accessing it, for example by checking the oil level with an oil dipstick or at the oil filter.

The method proposed here allows automatic analysis and makes it possible to warn the driver when the oil needs to be changed. It is also possible for an abnormal detection of the presence of metal chips to be carried out.

The initialization step can also make it possible both to check the correct operation of the system for determining the angular position of the engine and to check the condition/machining of the crankshaft target. Specifically, the factor calculated to estimate the amount of oil deposited should be substantially always the same for a new engine. In the example above, this factor should be substantially zero. A value that is too different than the theoretical value, corresponding for example to detection of a large oil deposit, is already a warning sign for the new engine that can be used as a means for checking (self-checking) the engine.

The present disclosure is not limited to the embodiment, the options and variants described solely by way of example hereinabove, but encompasses all of the variants that a person skilled in the art may envision within the scope of protection sought.

1. A method for detecting an oil deposit on a toothed target of a crankshaft in an internal combustion engine, the method comprising:
performing an initialization step, wherein the performing the initialization step comprises:
detecting an operating phase during which no combustion is carried out in the engine,
determining an initial rate of change in engine speed and measuring an initial passage time for each tooth of the toothed target over an interval of 360°CRK or 720°CRK,
determining a corrected initial passage time for each tooth of the toothed target based on the rate of change in the engine speed, and
storing the corrected initial tooth passage times,
performing a measuring step, wherein the performing the measuring step comprises:
detecting an operating phase during which no combustion is carried out in the engine,
determining a current rate of change in the engine speed and measuring a current passage time for each tooth of the toothed target over the same interval of 360°CRK or 720°CRK,
determining a corrected current passage time for each tooth of the toothed target based on the current rate of change in the engine speed, and
storing the corrected current tooth passage times, and
performing an analysis step, wherein the performing the analysis step comprises:
comparing the corrected current passage time for each tooth with an average passage time and calculating a relative rate of change between these two times,
calculating a factor representative of the relative rates of change for all of the teeth,
calculating the factor representative of the relative rates of change using the stored corrected initial passage times, and
detecting the oil deposit if the calculated factor representative of the relative rates of change using the stored corrected initial passage times differs from the calculated factor representative of the relative rates of change by more than a predetermined value.

2. The method as claimed in claim 1, wherein a first time (T_1) required for the engine to perform a first rotation of 720°CRK is measured, wherein a second time (T_2) required for the engine to perform a second rotation of 720°CRK immediately following the first rotation of 720°CRK, wherein the passage times for each tooth are measured and the rate of change in speed (DECEL) is calculated according to a formula:
DECEL=(T_2−T_1)/T_1.

3. The method as claimed in claim 2, wherein a correction rate (CDF) for calculating the corrected initial passage time and the corrected current passage time is:
CDF=DECEL*n/N
for the teeth in the interval [(n−1)*720°CRK; n*720°CRK],
with N being an integer and n<=N.

4. The method as claimed in claim 1, wherein the relative rate of change (TVR) in the corrected current passage time (T_mes_corr) and in the average passage time (T_moy) is given by a formula comprising:
TVR=1−(T_mes_corr/T_moy),
where T_moy corresponds to a sum of the current passage times divided by a number of the current times measured over the measurement interval.

5. The method as claimed in claim 1, wherein the factor representative of the relative rates of change consists of a sum of positive numbers.

6. The method as claimed in claim 1, wherein the method further comprises a warning step when the oil deposit is detected.

7. The method as claimed in claim 1, wherein each measurement begins at the passage of a reference tooth edge corresponding to a predetermined position modulo 720° of the engine.

8. A computer program comprising instructions that, when the program is executed by a computer, cause the computer to implement all of the steps of the method as claimed in claim 1.

9. An electronic control unit for managing the internal combustion engine, wherein the electronic control unit comprises means for implementing each of the steps of the method as claimed in claim 1.

10. A motor vehicle comprising the internal combustion engine with the crankshaft and the toothed target secured to the crankshaft, wherein the motor vehicle comprises the electronic control unit as claimed in claim 9.

11. An electronic control unit, wherein the electronic control unit includes a processor programmed to execute a set of program instructions stored in a memory, which when executed, cause the processor to:
perform an initialization step, wherein the initialization step comprises:
detecting an operating phase during which no combustion is carried out in an internal combustion engine;
determining an initial rate of change in engine speed and measuring an initial passage time for each tooth of a toothed target over an interval of 360°CRK or 720°CRK;
determining a corrected initial passage time for each tooth of the toothed target by taking into account the rate of change in the engine speed; and
storing the corrected initial tooth passage times in a non-volatile memory;
perform a measuring step, wherein the measuring step comprises:
detecting an operating phase during which no combustion is carried out in the engine;
determining a current rate of change in the engine speed and measuring a current passage time for each tooth of the toothed target over the same interval of 360°CRK or 720°CRK;
determining a corrected current passage time for each tooth of the toothed target by taking into account the current rate of change in the engine speed; and
storing the corrected current tooth passage times; and
an analysis step, wherein the analysis step comprises:
comparing the corrected current passage time for each tooth with an average passage time and calculating a relative rate of change between these two times;
calculating a factor representative of the relative rates of change for all of the teeth;
calculating the factor representative of the relative rates of change using the stored corrected initial passage times; and
detecting an oil deposit if the calculated factor representative of the relative rates of change using the stored corrected initial passage times differs from the calculated factor representative of the relative rates of change by more than a predetermined value.

12. The electronic control unit as claimed in claim 11, wherein a first time (T_1) required for the engine to perform a first rotation of 720°CRK is measured, wherein a second time (T_2) required for the engine to perform a second rotation of 720°CRK immediately following the first rotation of 720°CRK, wherein the passage times for each tooth are measured and the rate of change in speed (DECEL) is calculated according to a formula:
DECEL=(T_2−T_1)/T_1.

13. The electronic control unit as claimed in claim 12, wherein a correction rate (CDF) for calculating the corrected initial passage time and the corrected current passage time is:
CDF=DECEL*n/N
for the teeth in the interval [(n−1)*720°CRK; n*720°CRK],
with N being an integer and n<=N.

14. The electronic control unit as claimed in claim 11, wherein the relative rate of change (TVR) in the corrected current passage time (T_mes_corr) and in the average passage time (T_moy) is given by a formula comprising:
TVR=1−(T_mes_corr/T_moy),
where T_moy corresponds to a sum of the current passage times divided by a number of the current times measured over the measurement interval.

15. The electronic control unit as claimed in claim 11, wherein the factor representative of the relative rates of change consists of a sum of positive numbers.

16. The electronic control unit as claimed in claim 11, wherein each measurement begins at the passage of a reference tooth edge corresponding to a predetermined position modulo 720° of the engine.

17. A vehicle comprising:
an internal combustion engine comprising a crankshaft and a toothed target coupled to the crankshaft; and
an electronic control unit, wherein the electronic control unit includes a processor programmed to execute a set of program instructions stored in a memory, which when executed, cause the processor to:
perform an initialization step, wherein the initialization step comprises:
detecting an operating phase during which no combustion is carried out in the internal combustion engine;
determining an initial rate of change in engine speed and measuring an initial passage time for each tooth of the toothed target over an interval of 360°CRK or 720°CRK;
determining a corrected initial passage time for each tooth of the toothed target by taking into account the rate of change in the engine speed; and
storing the corrected initial tooth passage times in a non-volatile memory;
perform a measuring step, wherein the measuring step comprises:
detecting an operating phase during which no combustion is carried out in the engine;
determining a current rate of change in the engine speed and measuring a current passage time for each tooth of the toothed target over the same interval of 360°CRK or 720°CRK;
determining a corrected current passage time for each tooth of the toothed target by taking into account the current rate of change in engine speed; and
storing the corrected current tooth passage times; and
perform an analysis step, wherein the analysis step comprises:
comparing the corrected current passage time for each tooth with an average passage time and calculating a relative rate of change between these two times;
calculating a factor representative of the relative rates of change for all of the teeth;
calculating the factor representative of the relative rates of change using the stored corrected initial passage times; and
detecting an oil deposit if the calculated factor representative of the relative rates of change using the stored corrected initial passage times differs from the calculated factor representative of the relative rates of change by more than a predetermined value.

18. The vehicle as claimed in claim 17, wherein a first time (T_1) required for the engine to perform a first rotation of 720°CRK is measured, wherein a second time (T_2) required for the engine to perform a second rotation of 720°CRK immediately following the first rotation of 720°CRK, wherein the passage times for each tooth are measured and the rate of change in speed (DECEL) is calculated according to a formula:
DECEL=(T_2−T_1)/T_1.

19. The vehicle as claimed in claim 18, wherein a correction rate (CDF) for calculating the corrected initial passage time and the corrected current passage time is:
CDF=DECEL*n/N
for the teeth in the interval [(n−1)*720°CRK; n*720°CRK],
with N being an integer and n<=N.

20. The vehicle as claimed in claim 17, wherein the relative rate of change (TVR) in the corrected current passage time (T_mes_corr) and in the average passage time (T_moy) is given by a formula comprising:
TVR=1−(T_mes_corr/T_moy),
where T_moy corresponds to a sum of the current passage times divided by a number of the current times measured over the measurement interval.
